(19) United States
(12) Patent Application Publication
(10) Pub. No.: US 2026/0254160 A1
(43) Pub. Date: Aug. 27, 2026

(54) Low-Voltage Output Connector and Light String Controller

(71) Applicant: Guangzhou Ting Shen Electric Co., Ltd, Guangzhou (CN)

(72) Inventor: Chia-Chun Wang, Guangzhou (CN)

(21) Appl. No.: 19/171,478

(22) Filed: Apr. 7, 2025

(30) Foreign Application Priority Data
Feb. 24, 2025 (CN) 202520298102.X

(51) Int. Cl. H01R 13/622; F21V 23/06; H01R 13/504; H01R 13/52; H01R 13/627

(52) U.S. Cl. CPC H01R 13/622; F21V 23/06; H01R 13/504; H01R 13/5202; H01R 13/6277

(57) ABSTRACT

The present invention relates to a low-voltage output connector and a light string controller. The low-voltage output connector comprises a back cover, an output interface, and a nut that is threadedly engaged with the output interface. The output interface comprises a threaded column and a protrusion located at the base of the threaded column. One side of the protrusion is provided with a first inclined surface, and the other side is provided with a first stopping surface. The nut is threadedly connected to the threaded column, and the end of the nut is provided with several teeth. The side of the teeth facing the tightening direction is provided with a second inclined surface, and the side facing the loosening direction is provided with a second stopping surface. The present invention solves the problem of traditional controller output connectors being prone to loosening.

### CROSS REFERENCE TO RELATED APPLICATIONS

The present application claims the benefit of Chinese Patent Application No. 202520298102.X filed on Feb. 24, 2025, the contents of which are incorporated herein by reference in their entirety.

### TECHNICAL FIELD

The present invention pertains to the field of connector technology, specifically a low-voltage output connector used in light string controllers.

### BACKGROUND ART

Transformer power supplies are devices that convert input voltage through a transformer circuit and output the transformed voltage. These transformer power supplies are widely used in light strings. Currently, light strings typically require direct current (DC), while the mains supply outputs alternating current (AC). Therefore, a transformer power supply is needed between the light string and the mains supply. For example, Chinese Patent No. CN204696941U discloses a transformer power supply with AC and DC outputs, which includes a housing and a back cover. The back cover is located at one end of the housing, and an input interface is located at the other end. The back cover is equipped with at least one DC output interface and at least one AC output interface. The input interface, DC output interface, and AC output interface each have threads on their outer peripheries. However, in such transformer power supplies, the nuts can easily loosen under vibration or external force, leading to poor electrical contact or even short circuits.

### SUMMARY OF THE INVENTION

To solve the above technical problem, the technical solution of this application is as follows: A low-voltage output connector includes a back cover, an output interface provided on the back cover, and a nut in threaded fit with the output interface. The output interface includes a threaded column integrally molded with the back cover and a protrusion located at the base of the threaded column. The outer wall of the threaded column is provided with external threads, and a connection seat is provided inside the threaded column. The connection seat is equipped with an insertion hole. One side of the protrusion is provided with a first inclined surface, and the other side is provided with a first stopping surface. The inner wall of the nut is provided with internal threads, and the nut is threadedly connected to the threaded column. The end of the nut is provided with a plurality of teeth that engage with the protrusion. The side of the teeth facing the tightening direction is provided with a second inclined surface, and the side facing the loosening direction is provided with a second stopping surface. The principle of this application is as follows: Insert the light string wire into the insertion hole of the low-voltage output connector and tighten the nut. When the nut is fully tightened, the first inclined surface and the second inclined surface work together to guide the teeth of the nut over the protrusion. When the nut is rotated in the opposite direction, the first stopping surface and the second stopping surface interlock to prevent the nut from loosening.

As an improvement, the inner side of the back cover is provided with reinforcing ribs, and the edge of the inner side of the back cover is provided with an ultrasonic welding groove.

As another improvement, there are four protrusions evenly distributed around the circumference of the end of the nut.

To solve the above technical problem, another technical solution of this application is as follows: A light string controller includes a housing, an input interface located at the front end of the housing, and a low-voltage output connector located at the rear end of the housing. The low-voltage output connector includes a back cover, an output interface provided on the back cover, and a nut in threaded fit with the output interface. The output interface includes a threaded column integrally molded with the back cover and a protrusion located at the base of the threaded column. The outer wall of the threaded column is provided with external threads, and a connection seat is provided inside the threaded column. The connection seat is equipped with an insertion hole. One side of the protrusion is provided with a first inclined surface, and the other side is provided with a first stopping surface. The inner wall of the nut is provided with internal threads, and the nut is threadedly connected to the threaded column. The end of the nut is provided with a plurality of teeth that engage with the protrusion. The side of the teeth facing the tightening direction is provided with a second inclined surface, and the side facing the loosening direction is provided with a second stopping surface. The principle of this application is as follows: Insert the light string wire into the insertion hole of the low-voltage output connector and tighten the nut. When the nut is fully tightened, the first inclined surface and the second inclined surface work together to guide the teeth of the nut over the protrusion. When the nut is rotated in the opposite direction, the first stopping surface and the second stopping surface interlock to prevent the nut from loosening.

As an improvement, the inner side of the back cover is provided with reinforcing ribs, and the edge of the inner side of the back cover is provided with an ultrasonic welding groove.

As another improvement, there are four protrusions evenly distributed around the circumference of the end of the nut.

As a further improvement, the housing is formed by an upper shell and a lower shell joined together through ultrasonic welding, with two ultrasonic welding lines provided between the upper shell and the lower shell.

The beneficial effects of this application compared to the prior art are as follows:

The protrusions and teeth work together, with the inclined surfaces guiding and the stopping surfaces interlocking, effectively preventing the nut from loosening.

The protrusions are evenly distributed, serving both as an interlocking structure and as reinforcing ribs, enhancing mechanical strength and service life.

The ultrasonic welding groove and dual welding lines ensure the sealing of the housing and the connector.

### DESCRIPTION OF THE DRAWINGS

FIG. 1 is a schematic diagram of the application.

FIG. 2 is an exploded view I of the application.

FIG. 3 is an exploded view II of the application.

FIG. 4 is a schematic diagram of the back cover.

FIG. 5 is a schematic diagram of the nut.

### DETAILED DESCRIPTION

The present invention is further described in conjunction with the accompanying figures.

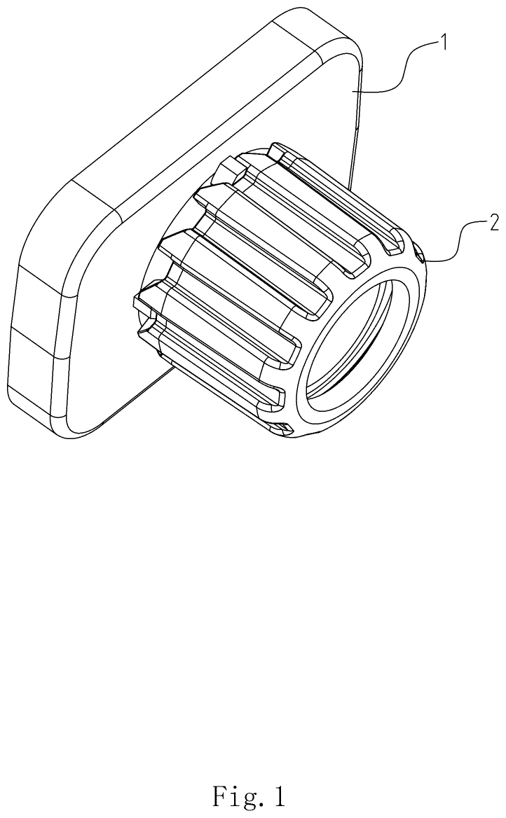

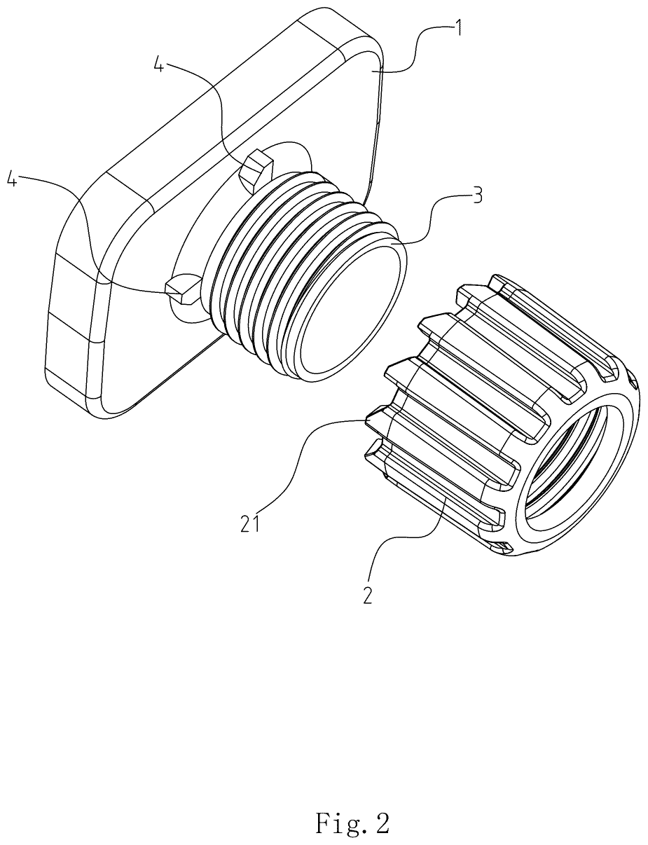

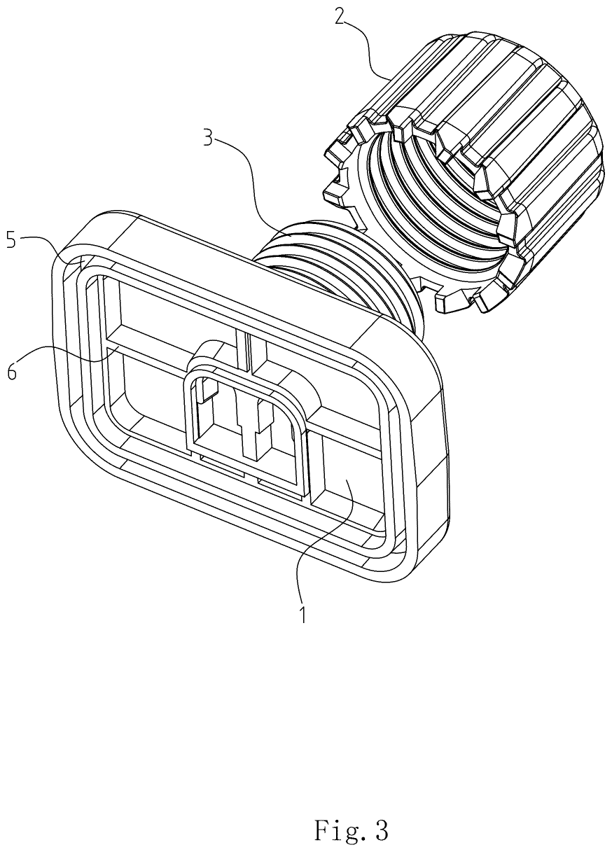

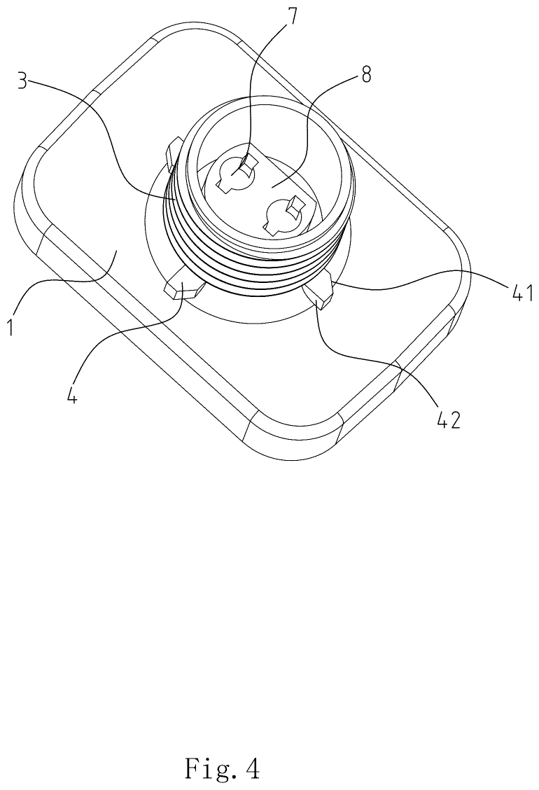

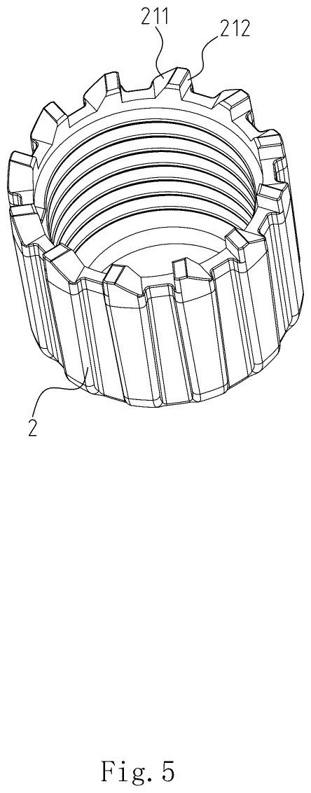

As shown in FIGS. 1 to 5, a light string controller includes a housing, an input interface located at the front end of the housing, and a low-voltage output connector located at the rear end of the housing. The housing is formed by an upper shell and a lower shell joined together through ultrasonic welding, with two ultrasonic welding lines provided between the upper shell and the lower shell, improving the overall waterproof performance of the housing. The low-voltage output connector includes a back cover 1, an output interface provided on the back cover 1, and a nut 2 that is threadedly engaged with the output interface. The output interface is located on the outer side of the back cover 1, and the inner side of the back cover 1 is provided with reinforcing ribs 6. The edge of the inner side of the back cover 1 is provided with an ultrasonic welding groove 5. The rear end of the housing is aligned with the ultrasonic welding groove and then ultrasonically welded, integrating the back cover 1 with the housing and improving the overall waterproof performance of the controller. The output interface includes a threaded column 3 integrally molded with the back cover 1 and a protrusion 4 located at the base of the threaded column 3. In this embodiment, there are four protrusions 4 evenly distributed around the circumference. The inner side of the protrusion 4 is connected to the threaded column 3, and the bottom of the protrusion 4 is connected to the back cover 1. The protrusion 4 serves as a reinforcing structure between the threaded column 3 and the back cover 1. The outer wall of the threaded column 3 is provided with external threads, and a connection seat 8 is provided inside the threaded column 3. The connection seat 8 is equipped with an insertion hole 7 for inserting conductors. One side of the protrusion 4 is provided with a first inclined surface 41, and the other side is provided with a first stopping surface 42. The inner wall of the nut 2 is provided with internal threads, and the nut 2 is threadedly connected to the threaded column 3. The end of the nut 2 is provided with a plurality of teeth 21. The side of the teeth 21 facing the tightening direction is provided with a second inclined surface 211, and the side facing the loosening direction is provided with a second stopping surface 212. The first inclined surface 41 and the second inclined surface 211 work together, and the first stopping surface 42 and the second stopping surface 212 work together.

The principle of this application is as follows: Insert the light string wire into the insertion hole of the low-voltage output connector and tighten the nut 2. When the nut 2 is fully tightened, the first inclined surface 41 and the second inclined surface 211 work together to guide the teeth 21 of the nut 2 over the protrusion 4. When the nut 2 is rotated in the opposite direction, the first stopping surface 42 and the second stopping surface 212 interlock to prevent the nut 2 from loosening.

What is claimed is:

1. A low-voltage output connector comprising:
a back cover;
an output interface provided on the back cover; and
a nut in threaded fit with the output interface;
wherein the output interface comprises a threaded column integrally molded with the back cover and a protrusion located at the base of the threaded column, the outer wall of the threaded column is provided with external threads, a connection seat is provided inside the threaded column, the connection seat is equipped with an insertion hole, one side of the protrusion is provided with a first inclined surface, and the other side is provided with a first stopping surface;
the inner wall of the nut is provided with internal threads, and the nut is threadedly connected to the threaded column, the end of the nut is provided with a plurality of teeth that engage with the protrusion, the side of the teeth facing the tightening direction is provided with a second inclined surface, and the side facing the loosening direction is provided with a second stopping surface.

2. The low-voltage output connector as recited in claim 1, wherein the inner side of the back cover is provided with reinforcing ribs, and the edge of the inner side of the back cover is provided with an ultrasonic welding groove.

3. The low-voltage output connector as recited in claim 1, wherein four protrusions are evenly distributed around the circumference of the end of the nut.

4. A light string controller comprising:
a housing;
an input interface located at the front end of the housing; and
a low-voltage output connector located at the rear end of the housing comprising:
a back cover, an output interface provided on the back cover, and a nut in threaded fit with the output interface;
wherein the output interface comprises a threaded column integrally molded with the back cover and a protrusion located at the base of the threaded column, the outer wall of the threaded column is provided with external threads, a connection seat is provided inside the threaded column, the connection seat is equipped with an insertion hole, one side of the protrusion is provided with a first inclined surface, and the other side is provided with a first stopping surface;
the inner wall of the nut is provided with internal threads, and the nut is threadedly connected to the threaded column, the end of the nut is provided with a plurality of teeth, the side of the teeth facing the tightening direction is provided with a second inclined surface, and the side facing the loosening direction is provided with a second stopping surface.

5. The light string controller as recited in claim 4, wherein the inner side of the back cover is provided with reinforcing ribs, and the edge of the inner side of the back cover is provided with an ultrasonic welding groove.

6. The light string controller as recited in claim 4, wherein four protrusions are evenly distributed around the circumference of the end of the nut.

7. The light string controller as recited in claim 4, wherein the housing is formed by an upper shell and a lower shell joined together through ultrasonic welding, with two ultrasonic welding lines provided between the upper shell and the lower shell.
